(19) United States
(12) Patent Application Publication
(10) Pub. No.: US 2008/0247588 A1
(43) Pub. Date: Oct. 9, 2008

(54) MULTIPLE CHANNEL EARPHONE AND STRUCTURE THEREOF

(75) Inventor: Bill Yang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: COTRON CORPORATION, Taipei City (TW)

(21) Appl. No.: 11/760,794

(22) Filed: Jun. 11, 2007

(30) Foreign Application Priority Data
Apr. 4, 2007 (TW) 96205490

(51) Int. Cl. H04R 25/00

(52) U.S. Cl. 381/371

(57) ABSTRACT

A multiple channel earphone is provided, which includes a chamber main body and a main chamber support located in the chamber main body. A front field mixing chamber, a main chamber, and a back chamber are formed in the chamber main body. The main speaker is located on the main chamber support or a partition board, a sub-speaker is disposed on a protruding portion of the chamber main body, and the back chamber is formed between the sub-speaker and the main chamber support or the partition board. In an embodiment, the multiple channel earphone structure further includes at least one or more pairs of chamber extension tubes disposed outside the chamber main body. According to the length of each chamber extension tube and the space in the chamber main body, a composite sound field characteristic generated in the earphone structure is adjusted and output by the multiple channel earphone.

### CROSS-REFERENCE TO RELATED APPLICATION

This application claims the priority benefit of Taiwan application serial no. 96205490, filed Apr. 4, 2007. All disclosure of the Taiwan application is incorporated herein by reference.

### BACKGROUND OF THE INVENTION

1. Field of the Invention

The present invention relates to a multiple channel earphone. More particularly, the present invention relates to a multiple channel earphone capable of adjusting the sound field.

2. Description of Related Art

With the development of digital technology, life and entertainment are gradually digitalized. For example, digital video disc (generally referred to as DVD) player has been used as a video player in common families. As the DVD player basically has the decoding function of Dolby digital or digital theater system (DTS), digital signals can be decoded, and analog signals are output to a speaker to generate the corresponding sound.

To enjoy a digital video recreational life of high quality, multiple channel speaker is an indispensable equipment, and a 5.1 channel speaker is the most basic one.

FIG. 1 is a schematic view of a home theater having a 5.1 channel speaker. Referring to FIG. 1, when the DVD player 100 plays a video, different sound signals are output to a left speaker 102a and a right speaker 102b of a front main channel, a center channel speaker 104, a left speaker 106a and a right speaker 106b of a surround channel, and a super bass speaker 108, so as to generate a three-dimensional sound effect to make people have the feeling of being personally on the scene.

However, in the circumstance that it is unsuitable to use a speaker to play the sound (for example, for fear of disturbing others), an earphone is needed. Referring to FIG. 2A, in an ordinary earphone 200a, only one speaker 210 is respectively disposed on the left and right sides, so the user cannot enjoy the multiple channel sound effect output by the DVD player.

Therefore, as shown in FIG. 2B, an earphone with a plurality of speakers is provided in the conventional art. For the earphone 200b, a front main channel speaker 202, a center channel speaker 204, and a surround channel speaker 206 are respectively disposed on the left and right sides, accompanied with a specially-designed plug 208, such that the DVD player can output sound signals of various channels to different speakers through the plug 208, so as to generate the 5.1 channel sound effect in the home theater as shown in FIG. 1. However, the conventional earphone 200b controls the delay of outputting the sound signals by a digital manner (for example, through circuit design), and the output sound field is relatively weak. As the output sound field is indeed much worse than the effect of the 5.1 channel speaker in the home theater as shown in FIG. 1, the quality and efficacy of the multiple channel surround sound effect cannot be revealed.

### SUMMARY OF THE INVENTION

Accordingly, the present invention is directed to provide a multiple channel earphone and a structure thereof. A front field mixing chamber, a main chamber, and a back chamber are formed in a chamber main body of an earphone main body. The main speaker is located on a main chamber support or a partition board, a sub-speaker is disposed at the back of the chamber main body, and a back chamber is formed between the sub-speaker and the main chamber support or the partition board. According to the space in the chamber main body, a composite sound field characteristic generated from the front field mixing chamber, the main chamber, and the back chamber formed in the earphone structure is adjusted and output by the multiple channel earphone.

The multiple channel earphone and the structure thereof further include a sub-speaker located on the side wall of the chamber main body. According to the space in the chamber main body, the composite sound field characteristic generated from the front field mixing chamber, the main chamber, and the back chamber formed in the earphone structure is adjusted.

The multiple channel earphone and the structure thereof further include one or more pairs of extension chambers located on the main cavity structure. Through the structure extended by the chamber extension tubes, the depth and width of the sound field are increased, such that the multiple channel earphone of the extension chamber still has a saturated sound field and multiple channel surround sound effect at a minimum volume.

One or more chamber extension tubes are disposed outside the chamber main body. According to the length of each chamber extension tube, the composite sound field characteristic formed in the earphone structure is changed, such that the composite sound field and the front field mixing chamber sound field are mixed and output by the multiple channel earphone.

In the multiple channel earphone structure, a sub-speaker is respectively disposed in at least two chamber extension tubes, for enhancing the effect of the composite sound field.

In the multiple channel earphone structure, the main speaker and the plurality of sub-speakers are respectively connected to a 5.1 multiple channel sound source output by a player suitable for digital versatile disc (DVD). In an embodiment, the main speaker is used as a front main channel speaker of the 5.1 multiple channel sound source, and one of the sub-speakers can be used as a super bass speaker, center channel speaker, or surround channel speaker.

In order to make the aforementioned and other objectives, features, and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a home theater having a 5.1 channel speaker.

FIG. 2A is a side sectional view of a conventional earphone.

FIG. 2B is a side sectional view of another conventional earphone.

FIGS. 3A to 3D are respectively a front side view, a back side view, a front view, and a back view of a multiple channel earphone according to a preferred embodiment of the present invention.

FIG. 3E is a partial sectional view and exploded view of a multiple channel earphone structure 300 according to a preferred embodiment of the present invention of FIGS. 3A to 3D.

FIGS. 4A to 4B are respectively a front side view and a back side view of a multiple channel earphone structure 400 according to another embodiment of the present invention.

FIG. 5 is a front side view and back side view of a multiple channel earphone structure 500 according to another embodiment of the present invention.

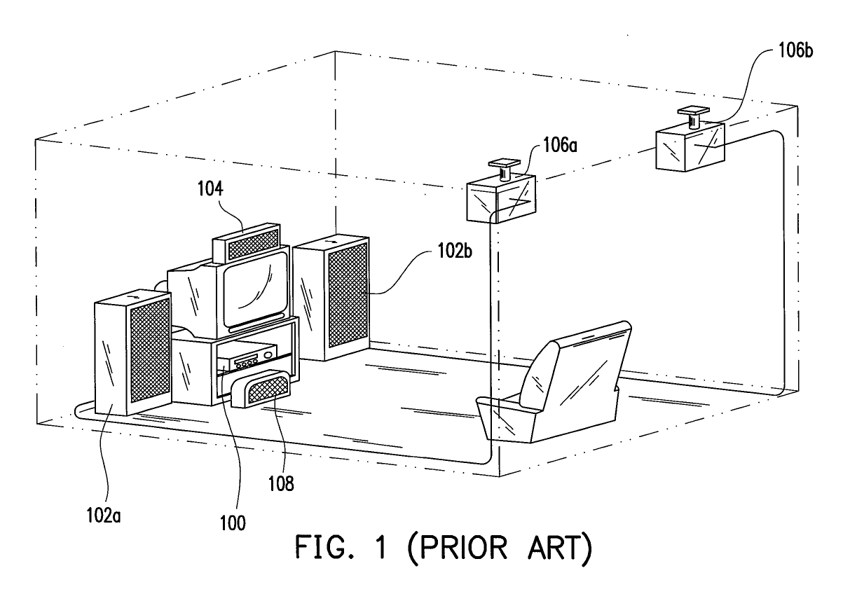

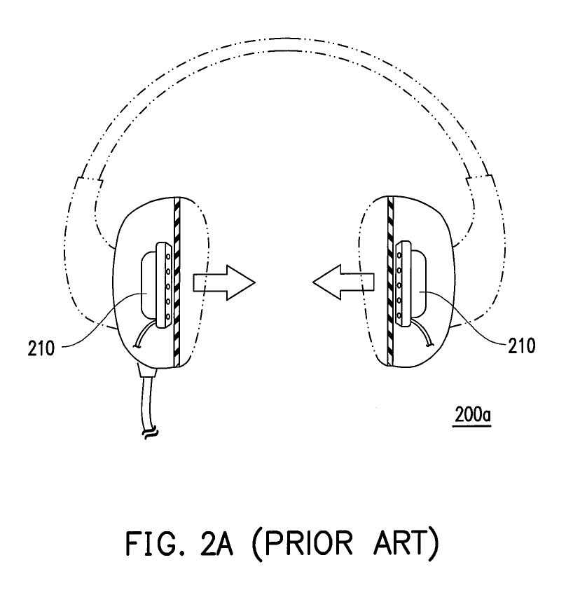

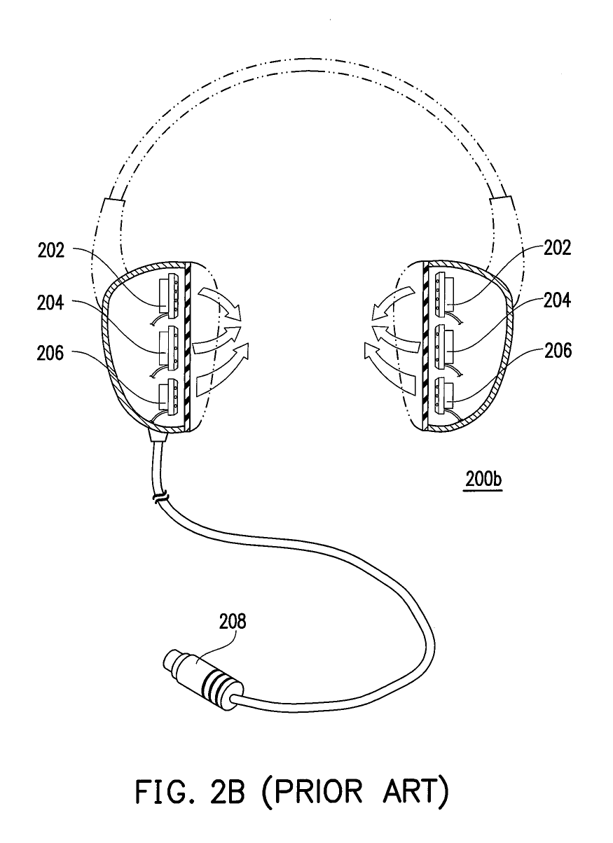

### DESCRIPTION OF EMBODIMENTS

The present invention provides a multiple channel earphone structure, capable of making the multiple channel earphone of the extension chamber still have a saturated sound field and multiple channel surround sound effect at a minimum volume.

The present invention provides a multiple channel and a structure thereof. The earphone main body includes a chamber main body and a main chamber support or a partition board located in the chamber main body. A front field mixing chamber, a main chamber, and a back chamber are formed in the chamber main body. The main speaker is located on the main chamber support or the partition board, a sub-speaker is disposed at the back of the chamber main body, and the back chamber is formed between the sub-speaker and the main chamber support. According to the space in the chamber main body, a composite sound field characteristic generated from the front field mixing chamber, the main chamber, and the back chamber formed in the earphone structure is adjusted and output by the multiple channel earphone.

In an embodiment, the multiple channel earphone and the structure thereof further include one or more chamber extension tubes disposed outside the chamber main body. A sub-speaker is selectively disposed on the outermost edge of each chamber extension tube outside the chamber main body. Each chamber extension tube makes proper arrangement on space structure according to the signal characteristic in the composite chamber cavity, and forms a part of the main sound field. The depth and the width of the sound field are increased through the extension structure of the chamber extension tube.

In the multiple channel earphone structure, the main chamber support has holes. A part of the holes are used to deliver a sound field generated from the back chamber to the front field mixing chamber to form the composite sound field characteristic. The other part of the holes are used to deliver a separate sound field generated from the pair of chamber extension tubes in the chamber main body to the front field mixing chamber to form the composite sound field characteristic.

In another selected embodiment, the multiple channel earphone and the structure thereof further include a plurality of sub-speakers located on the side wall of the chamber main body. According to the space in the chamber main body, the composite sound field characteristic generated from the front field mixing chamber, the main chamber, and the back chamber formed in the earphone structure is adjusted.

In another selected embodiment, the multiple channel earphone and the structure thereof further include one of more chamber extension tubes disposed outside the chamber main body. A sub-speaker is selectively disposed on the outermost edge of each chamber extension tube outside the chamber main body. Each chamber extension tube makes proper arrangement on space structure according to the signal characteristic in the composite chamber cavity. The depth and the width of the sound field are increased through the extension structure of the chamber extension tube.

In the above embodiments, the front field mixing chamber can selectively adopt the sound mixing material to achieve a better sound mixing effect. For example, foamed rubber ring is added to tune the tone.

The multiple channel earphone provided by the present invention is suitable for, for example, a 5.1 channel or 7.1 channel player. In an embodied embodiment, for example, any single signal of the 5.1 channel sound source output by the DVD player is separately drawn out of the sound tube chamber of the earphone main body. For example, if the earphone is applied to the 5.1 channel sound source of the DVD player, the main speaker is disposed at the back of the front field mixing chamber, and the super bass speaker is disposed at the back of the main speaker, i.e. at the back of the composite chamber cavity. In addition, the speaker of the surround sound field is disposed on the chamber extension tube for adjusting the depth and width of the sound field. Of course, the multiple channel earphone provided by the present invention is not merely suitable for the 5.1 channel sound source of the DVD player, and it severs as an example for illustration below without limiting the present invention.

Preferred embodiments are employed to illustrate the present invention as follows. It should be noted that the embodiments below are used for the ease of illustration instead of limiting the present invention.

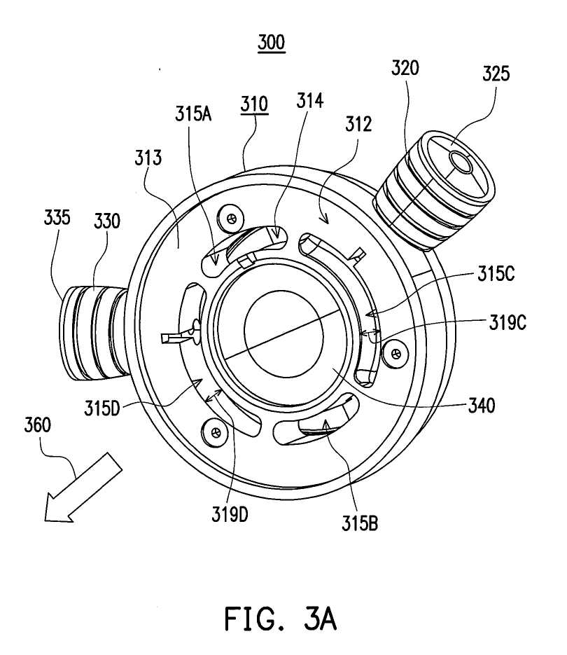

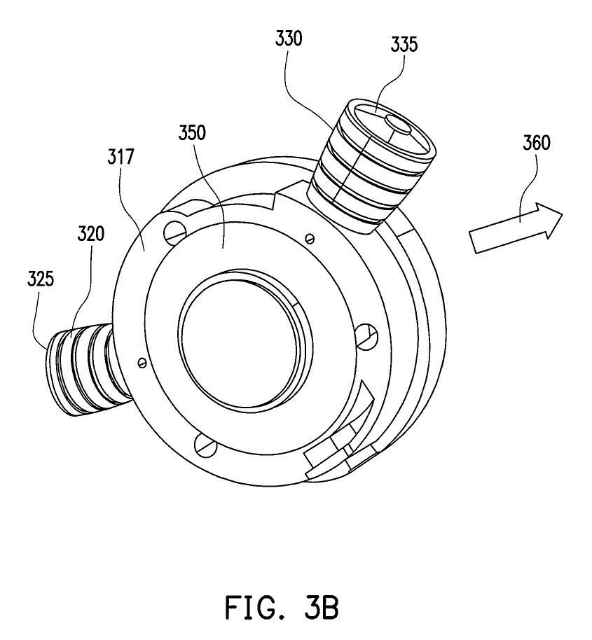

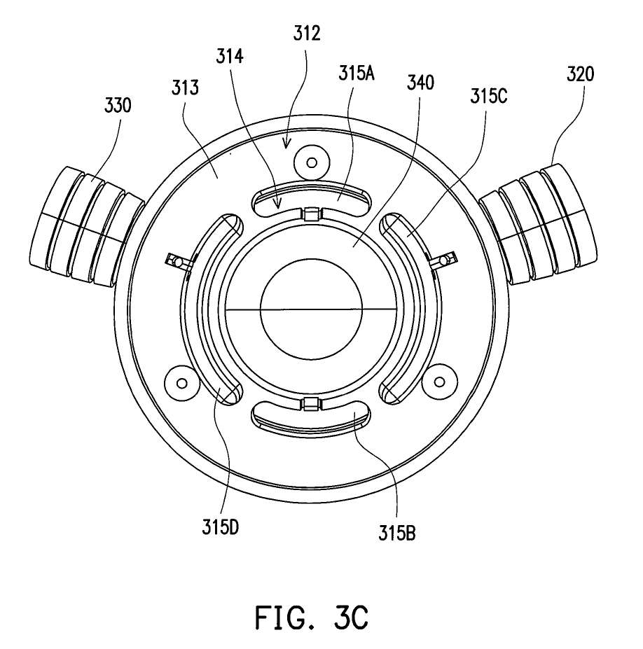

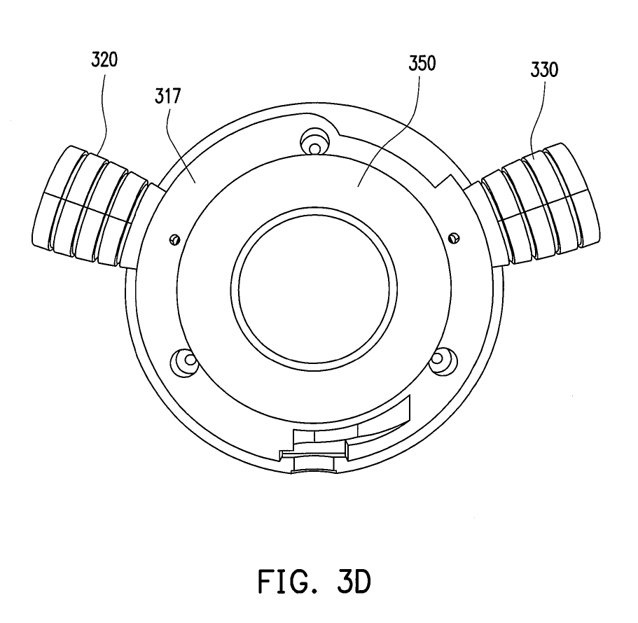

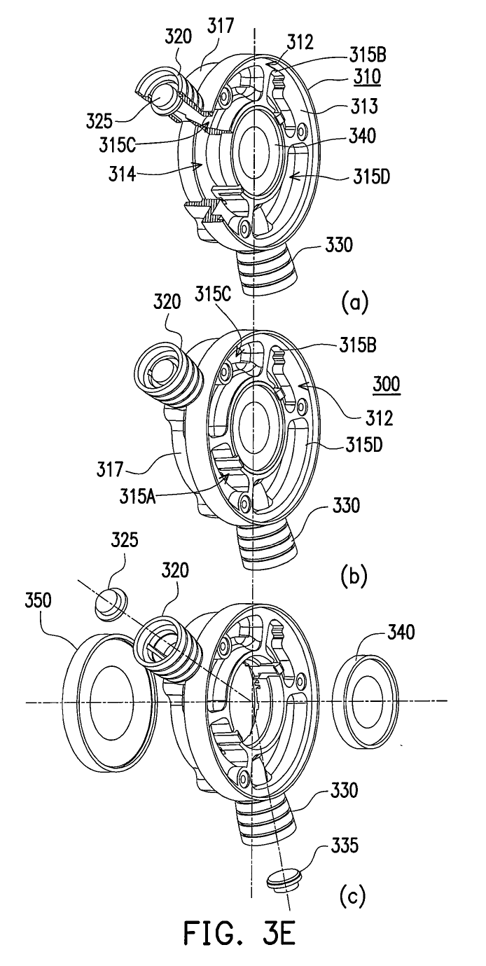

FIGS. 3A to 3D are respectively a front side view, a back side view, a front view, and a back view of a multiple channel earphone 300 according to a preferred embodiment of the present invention. It should be noted that, though FIGS. 3A to 3D only show one side of the earphone of the present invention, those skilled in the art should understand that the structure of the other side (not shown) is naturally the same as the side shown in FIGS. 3A to 3D, and the details will not be described herein again.

Referring to FIGS. 3A to 3D, the multiple channel earphone structure 300 at least includes a chamber maim body 310, a main speaker 340, a sub-speaker 350, and chamber extension tubes 320, 330. The chamber main body 320 includes a front field mixing chamber portion 312 and a back chamber portion 314. A main chamber support 313 is formed between the interior of the front field mixing chamber portion 312 and the back chamber portion 314. The main chamber support 313 has a plurality of holes 315A˜315D. The holes 315A and 315B are used to deliver a sound field generated from the back chamber portion 314 to the front field mixing chamber portion 312 to be mixed therein, and then delivered to a listener in the direction 360. The main speaker 340 is located between the plurality of holes 315A-315D on the main chamber support 313. The front field mixing chamber portion 312 has a certain depth in the direction 360 of the listener, so as to form a space to serve as the front field mixing chamber, in which the depth is designed according to the requirement of the multiple channel earphone structure 300.

The back chamber portion 314 forms a space between the main chamber support 313 and a protruding portion 317 at the back of the chamber main body 310, so as to form the back chamber cavity. The sub-speaker 350 is fixed on the protruding portion 317 at the back of the chamber main body 310.

The chamber extension tubes 320 and 330 are disposed at the periphery of the chamber main body 310, and in this embodiment the sound field exits respectively face the holes 315C, 315D of the main chamber support 313. The size of the separate chamber space formed by the main chamber support 313 in each of the holes 315C, 315D is a factor to be considered in the design of the earphone main cavity structure provided by the present invention, and the widths 319C, 319D of the separate chambers are also a feature in design. The sound fields generated from the separate chambers formed in the holes 315C and 315D are delivered to the front field mixing chamber portion 312 to be mixed therein, and then delivered to the listener in the direction 360.

The size can be changed according to the space distribution amount in the chamber main body 310 calculated according to the characteristics of the speaker. That is, the size can be adjusted according to the space of the main chamber, the back chamber, and the front field mixing chamber. A sub-speaker is selectively disposed on the outermost edge of the chamber extension tubes 320 and 330, for example, the sub-speakers 325, 335 as shown in the figure. Of course, in an embodiment, the outermost edge of the chamber extension tubes 320 and 330 may not be provided with a sub-speaker, and only serves as the extension of the main chamber cavity space. In the main chamber cavity, the chamber extension tubes 320 and 330 make proper arrangement on space structure according to the signal characteristic, to adjust the space in the main chamber cavity, so as to increase the depth and width of the sound field. Certainly, in another embodiment, the sound field exits of the chamber extension tubes 320 and 330 can also face the back chamber, which can be adjusted according to the requirement on design.

The chamber main body 310 and the chamber for extending the sound field constitute the body of the multiple channel earphone structure 300, and a proper space arrangement is made on the main chamber to form a suitable quantity of space sound field with the sound field space formed by the chamber of the chamber extension tubes 320 and 330 extending outside the chamber main body (for example, the sub-speakers 325 and 335) and the front and back speakers (the main speaker 340 and the sub-speaker 350) in the chamber. As such, the space sound field can match the tone tuning material disposed in the front field mixing chamber in the main cavity to form a saturated sound field with explicit levels, when the composite chamber receives a plurality of sound source signals.

The multiple channel earphone structure 300 provided in this embodiment can be applied to the 5.1 multiple channel sound source output by the DVD player. For example, the main speaker 340 is used as a front main channel speaker, the sub-speaker 350 is used as a super bass speaker, and the center channel speaker and the surround channel speaker are respectively located on the sub-speakers 325, 335 of the chamber extension tubes 320, 330. After being wrapped with a shell, the multiple channel earphone structure 300 becomes an earphone on the left/right side of the multiple channel earphone and is provided for the user to listen.

FIG. 3E is a partial sectional view and exploded view of the multiple channel earphone structure 300 according to the above embodiment of the present invention, in which identical elements are represented by the same symbols. The multiple channel earphone structure 300 at least includes a chamber main body 310, a main speaker 340, a sub-speaker 350, and chamber extension tubes 320, 330. The chamber main body 310 includes a front field mixing chamber portion 312, a back chamber cavity portion 314, and separate chamber portions respectively formed in the holes 315C, 315D after the chamber extension tubes 320, 330 arrange the space structure according to the signal characteristic. It can be clearly seen from the figure that, the sound field exits in the chamber extension tubes 320, 330 respectively face the space formed in the holes 315C, 315D of the main chamber support 313, so as to form the separate chamber with an adjustable space.

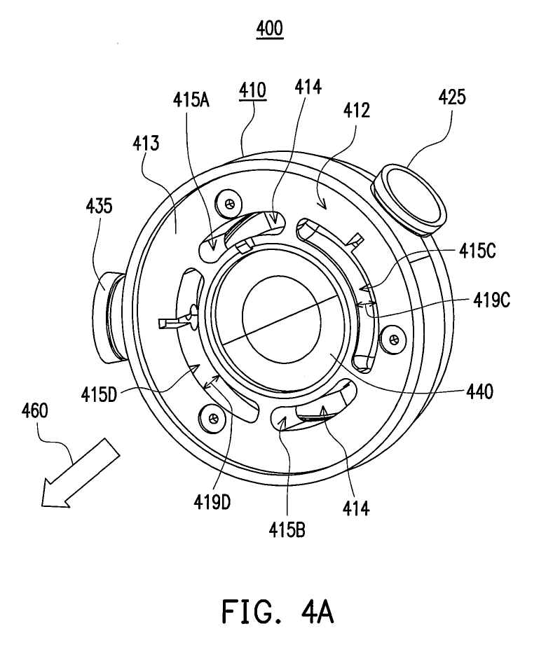

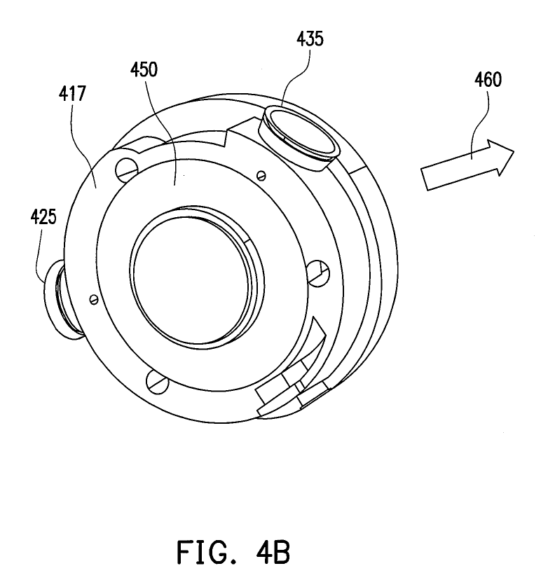

FIGS. 4A to 4B are a front side view and a back side view of a multiple channel earphone structure 400 according to another embodiment of the present invention. It should be noted that, though FIGS. 4A to 4B only show one side of the earphone of the present invention, those skilled in the art should understand that the structure of the other side (not shown) is naturally the same as the side shown in FIGS. 4A to 4B, and the details will not be described herein again.

Referring to FIGS. 4A to 4B, the multiple channel earphone structure 400 at least includes a chamber maim body 410, a main speaker 440, and a sub-speaker 450. The chamber main body 410 includes a front field mixing chamber portion 412 and a back chamber portion 414. A main chamber support 413 is formed between the interior of the front field mixing chamber portion 412 and the back chamber portion 414. The main chamber support 413 has a plurality of holes 415A-415D. The holes 415A and 415B are used to deliver a sound field generated from the back chamber portion 414 to the front field mixing chamber portion 412 to be mixed therein, and then delivered to a listener in the direction 460. The main speaker 440 is located between the plurality of holes 415A-415D on the main chamber support 413, and the front field mixing chamber portion 412 has a certain depth in the direction 460 of the listener, so as to form a space to serve as the front field mixing chamber, in which the depth is designed according to the requirement of the multiple channel earphone structure 400.

The back chamber portion 414 forms a space between the main chamber support 413 and a protruding portion 417 at the back of the chamber main body 410, so as to form the back chamber cavity. The sub-speaker 450 is fixed on the protruding portion 417 at the back of the chamber main body 410.

The difference from the embodiment of FIGS. 3A to 3E is that the chamber extension tube is not needed at the periphery of the chamber main body 410. However, the sub-speakers 425, 435 are disposed at the same position, and in this embodiment the sound field exits face the holes 415 of the main chamber support 413. The size of the separate chamber space formed by the main chamber support 413 in each of the holes 415C, 415D is a factor to be considered in the design of the earphone main cavity structure provided by the present invention, and the widths 419C, 419D of the separate chambers are also a feature in design. The sound fields generated from the separate chambers formed in the holes 415C, 415D are delivered to the front field mixing chamber portion 412 to be mixed therein, and then delivered to the listener in the direction 460.

The multiple channel earphone structure 400 provided in this embodiment can be applied to the 5.1 multiple channel sound source output by the DVD player. For example, the main speaker 440 is used as a front main channel speaker, the sub-speaker 450 is used as a super bass speaker, and the center channel speaker and the surround channel speaker are respectively used as the sub-speakers 425, 435. After being wrapped with a shell, the multiple channel earphone structure 400 becomes an earphone on the left/right side of the multiple channel earphone and is provided for the user to listen.

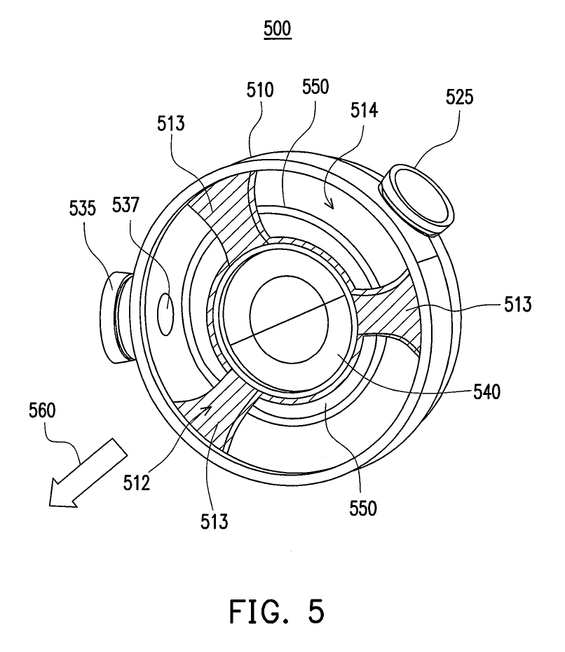

FIG. 5 is a front side view and back side view of a multiple channel earphone structure 500 according to another embodiment of the present invention. It should be noted that, though FIG. 5 only shows one side of the earphone of the present invention, those skilled in the art should understand that the structure of the other side (not shown) is naturally the same as the side shown in FIG. 5, and the details will not be described herein again.

Referring to FIG. 5, the multiple channel earphone structure 500 at least includes a chamber maim body 510, a main speaker 540, and a sub-speaker 550. The chamber main body 510 includes a front field mixing chamber 512 and a back chamber 514. A main chamber partition board 513 is formed between the interior of the front field mixing chamber 512 and the back chamber 514. The main chamber partition board 513 is mainly used to fix the main speaker 540. In addition, the sub-speaker 550 is fixed at the back of the chamber main body 510. The sound field generated from the back chamber 514 is delivered to the front field mixing chamber 512 to be mixed therein, and then delivered to a listener in the direction 560. The front field mixing chamber 512 has a certain depth in the direction 560 of the listener, so as to form a space to serve as the front field mixing chamber 512, in which the depth is designed according to the requirement of the multiple channel earphone structure 500.

The difference from the embodiment of FIGS. 3A to 3D is that the main chamber partition board 513 is located between the front field mixing chamber 512 and the back chamber 514, mainly for fixing the main speaker 540. In addition, the chamber main body 510 has chamber extension tubes and other sub-speakers as the embodiment of FIGS. 3A to 3D. Or, in another embodiment, as shown in FIG. 5, the sub-speakers 525, 535 are directly disposed outside the chamber main body 510. In this embodiment, the sound field exit indicated by the numeral 537 in the figure faces front field mixing chamber 512, which can be adjusted according to the requirement on design.

The multiple channel earphone structure 500 provided in this embodiment can be applied to the 5.1 multiple channel sound source output by the DVD player. For example, the main speaker 540 is used as a front main channel speaker, the sub-speaker 550 is used as a super bass speaker, and the center channel speaker and the surround channel speaker are respectively used as the sub-speakers 525, 535. After being wrapped with a shell, the multiple channel earphone structure 500 becomes an earphone on the left/right side of the multiple channel earphone and is provided for the user to listen.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A multiple channel earphone structure, comprising:
an earphone main body, having a chamber main body and a main chamber support, wherein the main chamber support has a plurality of holes, and a front field mixing chamber, a main chamber, and a back chamber are formed in the chamber main body;
a main speaker and a first sub-speaker, wherein the main speaker is located on the main chamber support, the first sub-speaker is disposed on a protruding portion of the chamber main body, and the back chamber is formed between the first sub-speaker and the main chamber support; and
at least one pair of chamber extension tubes, disposed outside the chamber main body, and respectively having an opening facing the interior of the chamber main body, so as to become a portion of the main chamber, wherein according to the inner space of the chamber main body and the space of the chamber extension tube, a composite sound field characteristic generated from the front field mixing chamber, the main chamber, and the back chamber formed in the earphone structure is adjusted and output by the multiple channel earphone.

2. The multiple channel earphone structure as claimed in claim 1, wherein a part of the holes of the main chamber support are used to deliver a sound field generated from the back chamber to the front field mixing chamber to form the composite sound field characteristic.

3. The multiple channel earphone structure as claimed in claim 1, wherein a part of the holes of the main chamber support are used to deliver a separate sound field generated from the pair of chamber extension tubes in the chamber main body to the front field mixing chamber to form the composite sound field characteristic.

4. The multiple channel earphone structure as claimed in claim 1, wherein a second sub-speaker and a third sub-speaker are respectively disposed in the pair of chamber extension tubes, and the generated sound fields respectively form a separate sound field in the inner space of the chamber main body.

5. The multiple channel earphone structure as claimed in claim 4, wherein the main speaker, the first sub-speaker, the second sub-speaker, and the third sub-speaker are respectively connected to a 5.1 multiple channel sound source output by a player suitable for digital versatile disc (DVD) according to their characteristics.

6. The multiple channel earphone structure as claimed in claim 5, wherein the main speaker is used as a front main channel speaker of the 5.1 multiple channel sound source, the first sub-speaker is used as a super bass speaker, and the second sub-speaker and the third sub-speaker are respectively used as a center channel speaker and a surround channel speaker.

7. A multiple channel earphone structure, comprising:
an earphone main body, having a chamber main body and a main chamber support, wherein the main chamber support has a plurality of holes, and a front field mixing chamber, a main chamber, and a back chamber are formed in the chamber main body;
a main speaker and a first sub-speaker, wherein the main speaker is located on the main chamber support, the first sub-speaker is disposed on a protruding portion of the chamber main body, and the back chamber is formed between the first sub-speaker and the main chamber support; and
at least a second speaker and a third speaker, disposed outside the chamber main body,
wherein according to the inner space design of the chamber main body, a composite sound field characteristic generated from the front field mixing chamber, the main chamber, and the back chamber formed in the earphone structure is adjusted and output by the multiple channel earphone.

8. The multiple channel earphone structure as claimed in claim 7, wherein a part of the holes of the main chamber support are used to deliver a sound field generated from the back chamber to the front field mixing chamber to form the composite sound field characteristic.

9. The multiple channel earphone structure as claimed in claim 7, wherein a part of the holes of the main chamber support are used to deliver a separate sound field generated from the chamber main body in the pair of chamber extension tubes to the front field mixing chamber to form the composite sound field characteristic.

10. The multiple channel earphone structure as claimed in claim 7, wherein the main speaker, the first sub-speaker, the second sub-speaker, and the third sub-speaker are respectively connected to a 5.1 multiple channel sound source output by a player suitable for DVD according to their characteristics.

11. The multiple channel earphone structure as claimed in claim 10, wherein the main speaker is used as a front main channel speaker of the 5.1 multiple channel sound source, the first sub-speaker is used as a super bass speaker, and the second sub-speaker and the third sub-speaker are respectively used as a center channel speaker and a surround channel speaker.

12. A multiple channel earphone structure, comprising:
an earphone main body, having a chamber main body and a main chamber partition board, wherein a front field mixing chamber, a main chamber, and a back chamber are formed in the chamber main body;
a main speaker and a first sub-speaker, wherein the main speaker is located on the main chamber partition board, the first sub-speaker is disposed on one side of the chamber main body, and the back chamber is formed between the first sub-speaker and the main chamber partition board; and
at least a second speaker and a third speaker, disposed outside the chamber main body, wherein according to the inner space design of the chamber main body, a composite sound field characteristic generated from the front field mixing chamber, the main chamber, and the back chamber formed in the earphone structure is adjusted and output by the multiple channel earphone.

13. A multiple channel earphone structure, comprising:
an earphone main body, having a chamber main body and a main chamber partition board, wherein a front field mixing chamber, a main chamber, and a back chamber are formed in the chamber main body;
a main speaker and a first sub-speaker, wherein the main speaker is located on the main chamber partition board, the first sub-speaker is disposed on one side of the chamber main body, and the back chamber is formed between the first sub-speaker and the main chamber partition board; and
at least one pair of chamber extension tubes, disposed outside the chamber main body, wherein according to the length of each chamber extension tube, a composite sound field characteristic generated from the front field mixing chamber, the main chamber, and the back chamber formed in the earphone structure is adjusted and output by the multiple channel earphone.

14. The multiple channel earphone structure as claimed in claim 13, wherein a second sub-speaker and a third sub-speaker are respectively disposed in the pair of chamber extension tubes.

15. The multiple channel earphone structure as claimed in claim 13, wherein the main speaker, the first sub-speaker, the second sub-speaker, and the third sub-speaker are respectively connected to a 5.1 multiple channel sound source output by a player suitable for DVD according to their characteristics.

16. The multiple channel earphone structure as claimed in claim 15, wherein the main speaker is used as a front main channel speaker of the 5.1 multiple channel sound source, the first sub-speaker is used as a super bass speaker, and the second sub-speaker and the third sub-speaker are respectively used as a center channel speaker and a surround channel speaker.
